(19) United States
(12) Patent Application Publication
(10) Pub. No.: US 2004/0189452 A1
(43) Pub. Date: Sep. 30, 2004

(54) Obstacle detection with time-slicing sensor control

(76) Inventor: Shih-Hsiung Li, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/403,371

(22) Filed: Mar. 31, 2003

(51) Int. Cl. B60Q 1/00

(52) U.S. Cl. 340/435

(57) ABSTRACT

An obstacle detection system that uses time-slicing function to control the synchronous operation of an array of sensors is provided. The system may include a large number of sensor devices installed around a vehicle operating synchronously, and a centralized synchronization and alarm control unit. Each sensor device has incorporated a microprocessor, and each sensor device includes an ultrasonic transducer and a microprocessor-based control unit, which is linked up with the synchronization and alarm control unit through the data bus. The sensor devices under the present invention are able to operate synchronously through the time-slicing function of the synchronization and alarm control unit, such that signals can be emitted and echoed signals can be received in an orderly manner with no risk of signal interference from adjoining sensor devices.

### BACKGROUND OF THE INVENTION

1. Field of the Invention

The present invention relates to an obstacle detection system using time-slicing function to control the synchronous operation of multiple sensor devices installed around a vehicle, in particular to a vehicle-mounted obstacle detection system that is capable of reducing the error rate in signal scanning.

2. Description of Related Arts

Ordinary obstacle detection system is only suited for sedans with ultrasonic sensors installed on the front and rear bumpers. For many heavy vehicles, such as trailer trucks, container trucks, cranes, and other heavy vehicles, the total length of this type of vehicle is often many times longer than a sedan, hence the operator in the front seat has to rely on electronic sensors to monitor the environmental conditions around the vehicle. These heavy vehicles usually have electronic sensors installed along side of the vehicle, in addition to the front and rear bumpers. There could be some 24 to 36 sensors all around a vehicle. However, the installation of this type of conventional sensor system would encounter a problem. The operation of conventional sensors is coordinated by a centralized sensor control unit. With such large number of sensors, the signal emission and reception time to be assignable to each sensor will be much decreased as the time slot is inversely proportional to the number of sensors installed. In order to maintain an adequate system response time, the number of sensors supported by a unit system has to be limited to four or less.

FIG. 5 shows a conventional sensor system employing four ultrasonic sensors (71-74) and a controller (70). These sensors (71-74) are arranged in sequential order, set by the controller (70), to emit signals and scan for echoed signals. For the heavy vehicles mentioned above, each vehicle would need 6 to 8 sets of such sensor system, under the conventional architecture, in order to cover all 24 to 36 sensors. In FIG. 6, the sensors surrounding the vehicle are respectively connected to matching sensor control units (70A-70H), which are then fed to an alarm (80).

The critical issue is that two adjoining sensors may be belonging to different sensor control units and each one operates at somewhat different pace. Again referring to FIG. 6, for example, the last sensor (74) to the control unit (70A) and the first sensor (71) to the control unit (70B) are next to each other, but they are controlled by different control units with no synchronization. In this case, there could chances that a signal emitted by the fourth sensor (74) belonging to the first control unit (70A) may be picked up by the first sensor (71) belonging to the second control unit (70B), thus resulting in error signal reception and false alarm.

To correct the error rate in signal scanning and synchronize the operation for all sensors, a synchronization means is needed to arrange the firing sequence for all sensors (71-74) and control units (70A-70H), so as to prevent the activation of false alarm by two adjoining sensors operating at different pace, but then there is another problem with the degradation of the system response time due to the reduction of assignable time slot for each sensor.

One possible solution is to allow a synchronization and alarm control unit to set the pace for the control units (70A-70H), only that the cost of such installation is too expensive. The sensors and controllers in such a system all have to be installed at predetermined positions to be able to meet the signal emission and reception specifications without mutual interference, and the related wiring could also be very complicated.

### SUMMARY OF THE INVENTION

The main object of the present invention is to provide an obstacle detection system using time-slicing function to control a large number of sensor devices operating synchronously, so as to avoid error signal reception and false alarm.

The obstacle detection system in accordance with the present invention includes multiple microprocessor-controlled sensor devices, which are interconnected through a data bus, and a synchronization and alarm control unit is used to synchronize the operation of all sensor devices as the control unit is also connected to the above sensor devices through the data bus. Each sensor device includes an ultrasonic transducer and a microprocessor-based controller.

Each sensor device with the microprocessor is operated independently, but the synchronization and alarm control unit is responsible for synchronizing the operation of all sensor devices by means of a time-slicing control function, such that two adjoining sensor devices can be coordinated to operate at a slightly different pace to prevent error signal reception.

The present invention is also capable of keeping the installation cost relatively low with the simplified system architecture.

### BRIEF DESCRIPTION OF THE DRAWINGS

FIG. 1 is a schematic diagram of the system architecture of the present invention;

FIG. 2 is a block diagram of the architecture of a microprocessor controlled sensor device;

FIG. 3 is a block diagram of the architecture of the synchronization and alarm control unit;

FIG. 4 is an actual implementation of an obstacle detection system using time-slicing sensor control;

FIG. 5 a block diagram of the architecture of a conventional sensor system; and

FIG. 6 is a possible implementation of the conventional sensor system.

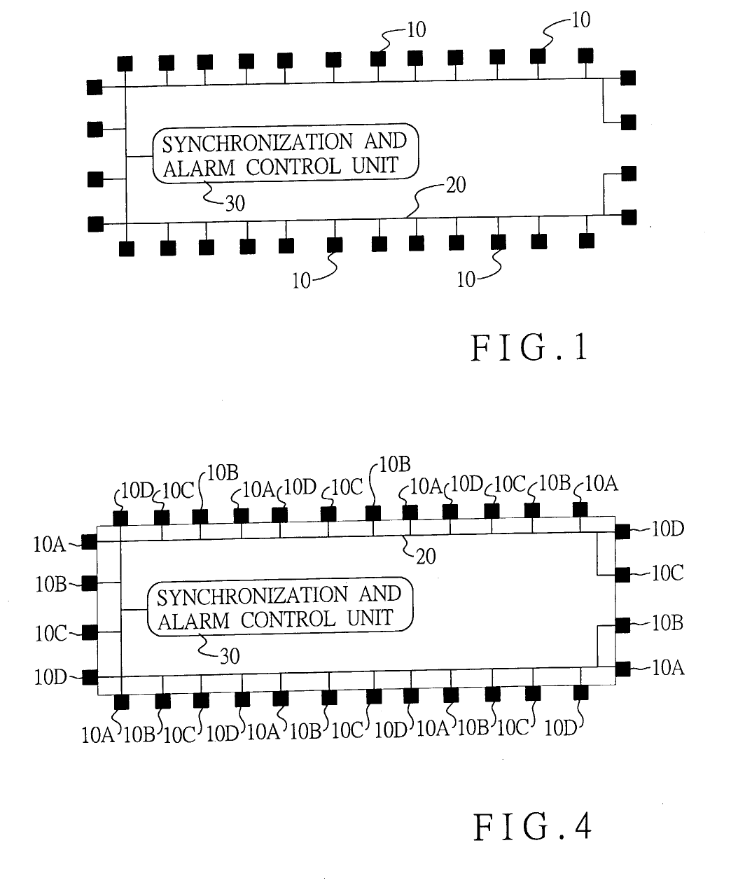

### DETAILED DESCRIPTION OF THE PREFERRED EMBODIMENT

The present invention provides an obstacle detection system using time-slicing function to control multiple sensor devices installed around a vehicle. The architecture of the system includes multiple sensor devices (10) at various locations, a data bus (20) and a synchronization and alarm control unit (30), wherein the sensor devices (10) are interlinked through the data bus (20) and respectively installed at desirable positions around a vehicle; and the centrally located synchronization and alarm control unit (30) is also connected to all sensor devices (10) through the data bus (20).

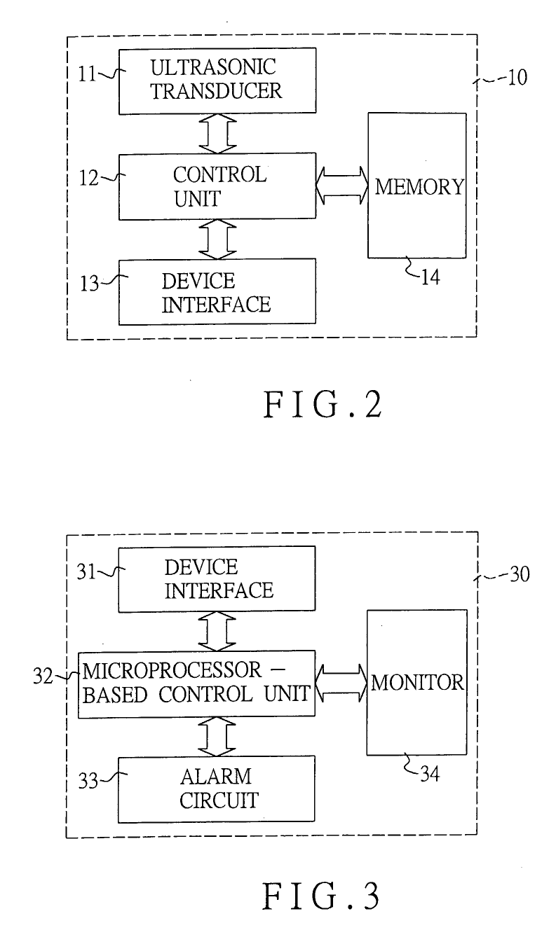

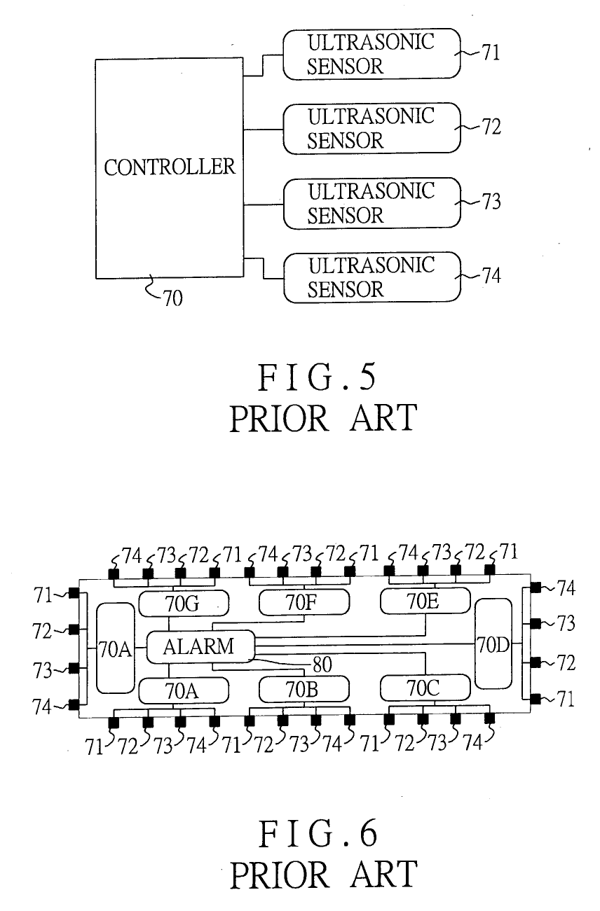

FIG. 2 shows the architecture of a microprocessor-controlled sensor device. Each sensor device (10) is composed of an ultrasonic transducer (11), a microprocessor-based control unit (12), and a device interface (13), wherein the control unit (12) is connected to the data bus (20) through the device interface (13), such that the sensor device (10) is placed under the system control of the synchronization and alarm control unit (30).

The sensor device (10) further includes a memory (14), which is used to record the environmental conditions when the system is initially activated, and then the recorded data are then used to compare with subsequently scanned data for computing the relative distance from the sensor position to the obstacle and also for determining whether issue a warning signal once the threshold value is arrived.

FIG. 3 shows the architecture of a synchronization and alarm control unit (30), comprising at least includes one set of device interface (31) for linking up sensor devices (10), microprocessor-based control unit (32) and alarm circuit (33). The microprocessor-based control unit (32) is used to control the operation of all sensor devices (10) through the data bus (20), such that each sensor device (10) is able to operate in sequence for emitting signals and receiving echoed signals. The microprocessor-based control unit (32) is also responsible for activating the alarm circuit (33) if the threshold value is met. The output from the synchronization and alarm control unit (32) can be connected to a monitor (34) to display the relative distance, from the sensor position to an obstacle, computed by respective sensor devices (10).

The detailed operation of the various functional units is to be described below. Under the present architecture, each sensor device (10) is connected to the centrally located synchronization and alarm control unit (30), and each sensor device (10) also has incorporated a microprocessor to communicate with the synchronization and alarm control unit (30), such that each sensor device (10) is able to operate synchronously under a time-sharing mode.

FIG. 4 shows 32 sensor in groups of four (10A-10D) as these sensors are coordinated by means of a duty cycle containing four different time slots. In the first time slot, one quarter of the sensor devices (10A), one in every four non-adjoining sensor positions, are activated for normal sensor operation, whilst the other three quarters of sensor devices (10B-10D) are placed in a standby mode. In the second time slot, the second quarter of sensor devices (10B) in non-adjoining positions are switched to the active mode as in the above situation, and the originally operating first quarter of sensor devices (10A) begins to enter the standby mode, whilst the other sensor devices (10C, 10D) remain in the standby mode. In the third time slot, the third quarter of non-adjoining sensor devices (10C) are switched to the active mode, and the originally operating second quarter of sensor devices (10B) is switched to the standby mode, whilst other sensor devices (10A, 10C) remain in the standby mode, and finally, in the fourth time slot, the fourth quarter of non-adjoining sensor devices (10D) are switched to the active mode, and the originally operating third quarter of sensor devices (10C) is switched to the standby mode, whilst other sensor devices (10A, 10B) remain in the standby mode. The operation cycle is continuously repeated in the same order until the system is cut off.

Since each sensor device (10A-10D) and the synchronization and alarm control unit (30) all have an independent microprocessor to pace their operation, the whole system is able to operate in an orderly manner without signal errors and mutual interference.

In sum, the present invention is advantageous with a number of reasons to be explained below.

(1) No signal conflict for all sensor devices under the above mentioned operating principles.

(2) Not necessary to restrict the sensor position during installation: According to the present invention, a serial identification can be assigned to each sensor device after the sensor device is installed at the desired locations. The number generation could be done by means of a portable number generator, and the numbers are then input to the respective sensor devices. At the same time the numbers are registered in the memory of various sensor devices as referencing data, such that the synchronization and alarm control unit is able to assign the order of operation in accordance with established number sequence.

(3) Simplified wiring: Having all functional units interconnected through a common data bus, the present invention is able to avoid the complicated electrical wiring and noise interference problems.

(4) Memory capability: Since each sensor device has incorporated a microprocessor with working memory, it can record the initial environmental conditions when the system is first activated, which is then compared with subsequently sampled data for more accurate calculation of the relative distance from the sensor position to an obstacle.

The foregoing description of the preferred embodiments of the present invention is intended to be illustrative only and, under no circumstances, should the scope of the present invention be so restricted.

What is claimed is:

1. An obstacle detection using time-slicing sensor control, comprising multiple microprocessor-controlled sensor devices, a data bus, and a synchronization and alarm control unit, wherein each sensor device is installed at a different position around a vehicle, and each sensor device further includes an ultrasonic transducer, a microprocessor-based control unit, and a device interface, such that the synchronization and alarm control unit is connected to the data bus, over which all sensor devices are interconnected for synchronized operation through their device interface.

2. The obstacle detection system as claimed in claim 1, wherein the sensor device further includes a memory that is installed in the control unit.

3. The obstacle detection system as claimed in claim 1, wherein the synchronization and alarm control unit includes at least one set of device interface, and a microprocessor and an alarm circuit, whereby the microprocessor is connected to the data bus through the device interface, and the output is connected to the alarm circuit.

4. The obstacle detection system as claimed in claim 3, wherein the output of the microprocessor can also be connected to a monitor for displaying the relative distance from the position of a sensor to the obstacle computed by the respective sensor devices.
